(19) United States
(12) Patent Application Publication
(10) Pub. No.: US 2005/0205691 A1
(43) Pub. Date: Sep. 22, 2005

(54) Double acting pneumatic three-way valve for handling coating solution

(76) Inventor: Todd Robida, Southbridge, MA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/801,307

(22) Filed: Mar. 16, 2004

(51) Int. Cl. B05B 9/04

(52) U.S. Cl. 239/320; 239/329; 239/331

(57) ABSTRACT

A double pneumatic acting valve includes a default neutral state so that the valve seats remain open when not in use, which prevents gluing of the valve seats in the closed position. The valve can be used in a medical device coating application unit, which is adapted to apply a coating solution (i.e., a solution or suspension that contains an organic liquid or an aqueous-organic liquid as well as a polymer, a pharmaceutical additive, or both a polymer and a pharmaceutical additive) to a medical device. The three-way valve is in fluid communication with a reservoir containing the coating solution. An outlet is provided for applying the coating to the medical device. A receptacle is included for withdrawing the coating solution from the reservoir when the valve is in a first position and for expelling the withdrawn the coating solution through the outlet port when the valve is in a second position. The valve includes two tubing connections coupled to two pneumatically actuated valves. The first valve includes a first pneumatically actuated plunger, and is coupled to one of the tubing connections. The second valve includes a second pneumatically actuated plunger, and is coupled to the other tubing connection. The second plunger is disposed opposite the first plunger.

### FIELD OF THE INVENTION

The present invention relates generally to methods and apparatuses for handing solutions and dispersions of polymers and/or pharmaceutical additives, and more particularly to a method and apparatus for coating medical devices, in which such solutions and dispersions are handled.

### BACKGROUND

An example, of a known three-way value is the Takasago three-way valve, which is a pneumatically activated valve with a spring return, and is illustrated in FIGS. 2-8. Briefly, FIG. 2 shows a Takasago three-way valve as coupled to one of the hoses. FIG. 3 shows the Takasago three-way valve in a side view. FIG. 4 shows a section view along sectional lines B-B in FIG. 3. FIG. 5 shows a detail view of area D from FIG. 5. FIG. 6 shows a section view along sectional lines C-C in FIG. 3. Nitrogen is often used as the valve operating gas. The PTFE valve seats are mechanically interlocked with a small ceramic stem. If one seat closes, the other opens and vice versa. FIGS. 7-8 show additional views of the valve. FIG. 7 shows a sectional view. FIG. 8 shows a top view. The three-way valves include Takasago Part Numbers PDMP-2E1/4U-2 (single acting valve with spring return and plastic components), PDMS-2E1/4U-3 (single acting valve with spring return and stainless steel components), and PDMS-2E1/4-DR (double acting valve with stainless steel components). The above figures are discussed in more detail below.

When used to handle polymeric solutions in methods and apparatuses for coating medical devices, several problems have been observed with 3-way valves such as that above. The problems are primarily associated with valve seats not opening or closing or with valves being improperly plumbed. Many failures have been observed to occur after a break in usage, for example, after an overnight break or a lunch break. Another contributor to the failures is the use of a plastic valve body. Cross threading occurs regularly and sometimes causes leaks. Repeated removal and installation of fittings into a damaged valve body tends to exacerbate the problem.

### SUMMARY OF THE INVENTION

The present invention solves these and other problems by providing methods and apparatuses that utilize a double pneumatic acting valve, preferably with a default neutral state so that the valve seats remain open when not in use, thereby preventing seizure of the valve seats in the open or closed position.

According to one aspect of the present invention, a method for coating a medical device uses a dual pneumatic actuated three-way valve for a medical device coating application unit and maintains all valve seats open when the unit is not in use. The coating application unit is adapted to apply a coating solution to a medical device. A default neutral state is provided for the three-way valve so that all valve seats are maintained open when the device is not in use. Such a medical device coating application unit is advantageous, for example, in that consistent coating weights are achieved.

As used herein, the term “coating solution” refers to a solution or suspension that contains (a) an organic liquid or an aqueous-organic liquid and (b) a polymer or a pharmaceutical additive or both a polymer and a pharmaceutical additive. A “pharmaceutical additive” is an active or inactive pharmaceutical agent or excipient.

The term “polymeric solution” refers to polymeric solutions or suspensions that contain (a) an organic or organic-aqueous liquid, (b) a polymer and (c) an optional pharmaceutical additive.

According to another aspect of the present invention, a medical device coating application system includes a dual pneumatic actuated three-way valve in fluid communication with a reservoir containing a coating solution. An outlet port is provided for applying the solution to a medical device. A receptacle is included for withdrawing the solution from the reservoir when the valve is in a first position and for expelling the withdrawn solution through the outlet port when the valve is in a second position.

According to still another aspect of the present invention, a three-way valve for use in a medical device coating application system includes two tubing connections and two pneumatically actuated valves. The first valve includes a first pneumatically actuated plunger, and is coupled to one of the tubing connections. The second valve includes a second pneumatically actuated plunger, and is coupled to the other tubing connection. The second plunger is disposed opposite the first plunger. When the medical device coating application system is not in use the first and second valves are maintained open, thereby preventing dried agents from gluing the valve seats closed.

According to yet another aspect of the present invention, a method for manufacturing a three-way valve includes disassembling a first symmetric three-way valve and reassembling the first valve backwards, and replacing a spring return of a second identical valve with the backwards-assembled first valve. In addition, the method includes attaching the backwards-assembled first valve to a valve body of the second valve using a bracket from the second valve, as well as drilling out and counter boring two tapped holes in a valve bracket and using the valve bracket to attach the pneumatic plunger portion from the first valve to a valve body of the second valve.

The above and other aspects of the present invention will be apparent upon review of the following drawings in light of the detailed description.

### BRIEF DESCRIPTION OF THE DRAWINGS

FIG. 1 depicts an existing stent-spraying apparatus.

FIGS. 2-3 depict an existing three-way valve used in the stent-spraying apparatus of FIG. 1.

FIG. 4 depicts a sectional view of the three-way valve in FIG. 2 along section line B-B.

FIG. 5 depicts a blowup view of detail D in FIG. 4.

FIG. 6 depicts a sectional view of the three-way valve in FIG. 3 along sectional line C-C.

FIGS. 7-8 depict a three-way valve.

FIG. 9 depicts an exemplary embodiment of a three-way valve in a top view according to one aspect of the present invention.

FIG. 10 depicts the exemplary embodiment of FIG. 9 in a rear view.

FIG. 11 depicts a cross-sectional view of the exemplary embodiment of FIG. 10 along section line D-D shown in FIG. 10.

FIGS. 12-13 depict an existing valve bracket in a side view and top view, respectively.

FIGS. 14-16 depict modifications made to the bracket of FIGS. 12-13 for use in the embodiment of FIG. 10 according to yet another aspect of the present invention.

### DETAILED DESCRIPTION

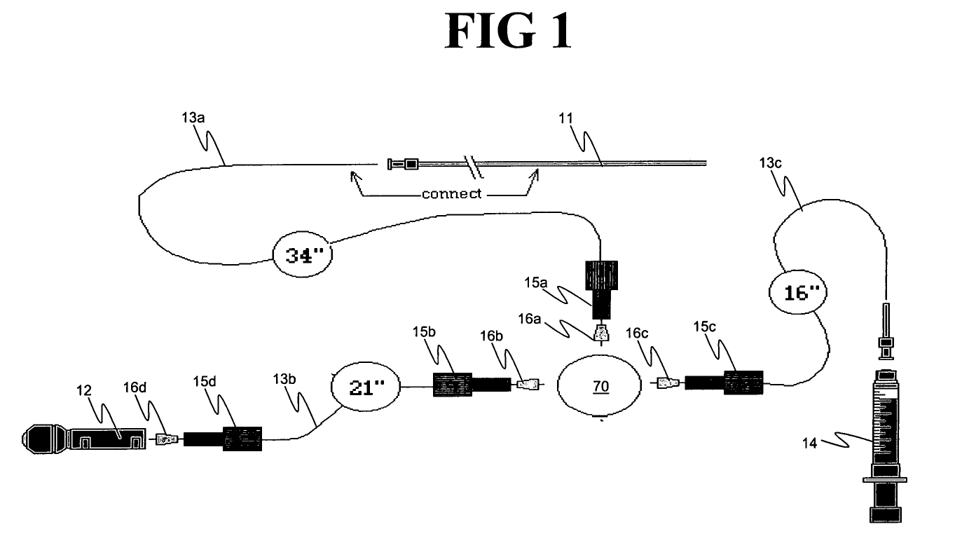

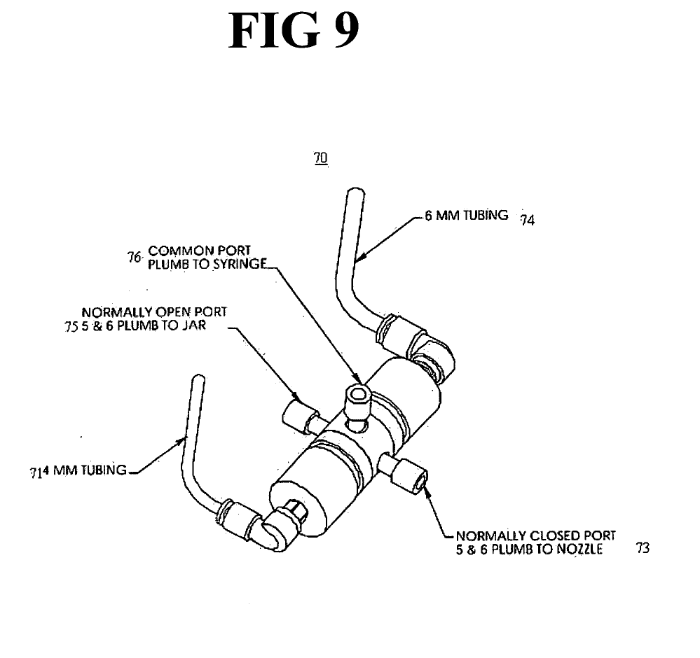

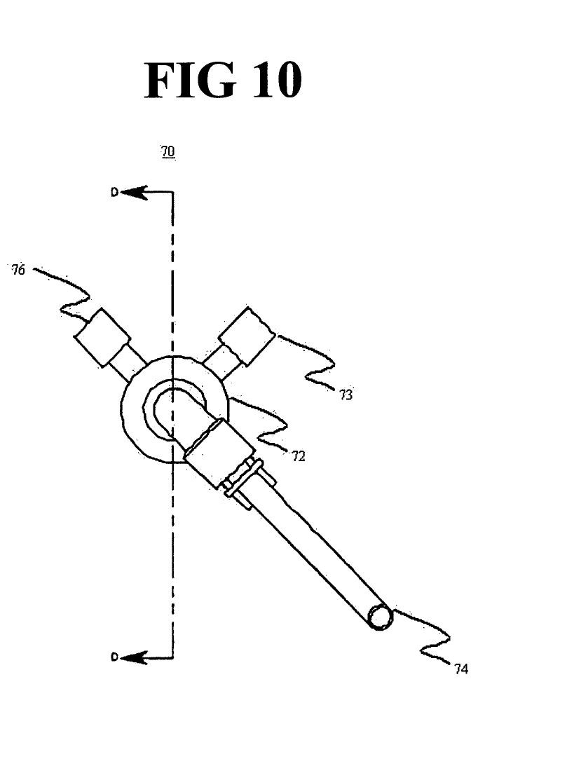

Shown in FIG. 9 is an exemplary embodiment 70 of a three-way valve according to one aspect of the present invention, which inter alia solves the above-mentioned problems. The embodiment 70 can be used in the stent-spraying apparatus shown in FIG. 1, as well as in other potential applications.

Referring to FIG. 1, an embodiment of a medical device coating application system is illustrated, which includes the embodiment 70 of a dual pneumatic actuated three way valve illustrated in FIG. 9. The embodiment 70 has three ports, which are in fluid communication via ⅛″ lines 13a, 13b, 13c with the following: (a) a pipette needle 11, which is immersable in a reservoir (e.g., ajar, not illustrated) containing a coating solution (e.g., a polymeric solution), (b) a spray nozzle 12, and (c) a receptacle 14 (e.g., a syringe) for receiving the coating solution from the reservoir via pipette needle 11 when the valve is in a first position, and for expelling the withdrawn coating solution through the spray nozzle 12 when the valve is in a second position. Connections are enhanced by the use of flangeless nuts 15a, 15b, 15c, 15d and flangeless ferrules 16a, 16b, 16c, 16d (e.g., P-330X ⅛″ flangeless nuts and ferrules, available from Upchurch Scientific).

Referring to FIG. 9, four millimeter tubing 71 connects to one end of the three-way valve, which is coupled to a nitrogen source for controlling the valve. Six millimeter tubing 74 connects to the other end of the three-way valve, which is also coupled to a nitrogen source for controlling the valve. According to one aspect of the present invention, when the nitrogen pressure is removed, a default neutral state is achieved in which both valve seats of the three-way valve are open, thereby preventing solids buildup or gluing of the valve seats closed by drying agents. Three valve ports are available 73, 75 and 76 for use to couple to a reservoir, a spray nozzle and syringe, or other applications requiring three valves.

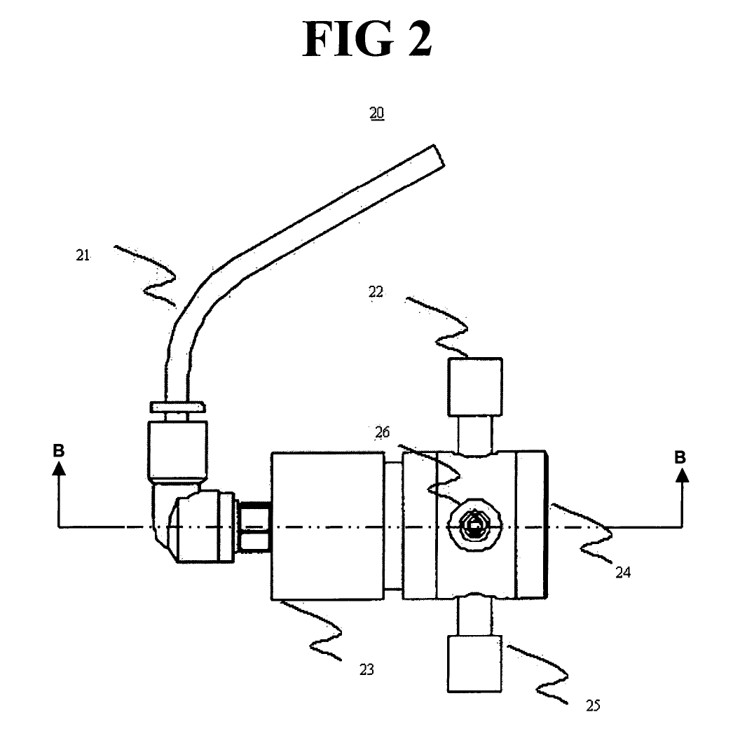

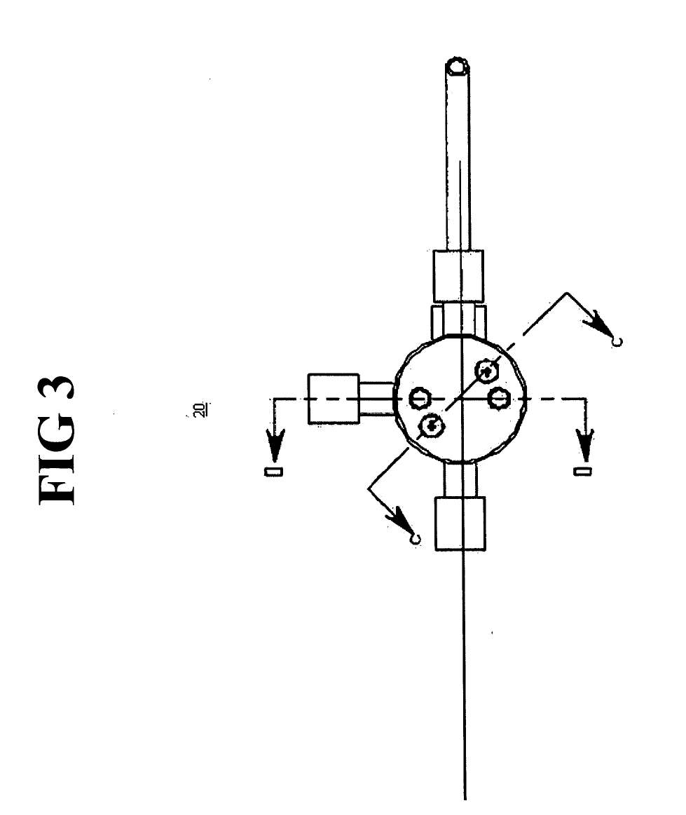

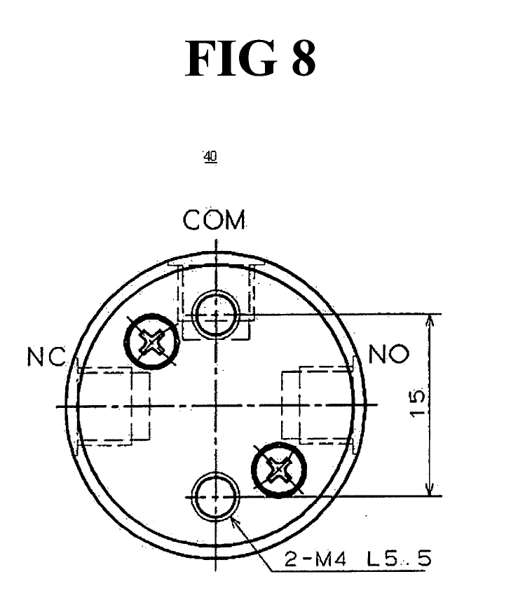

The embodiment 70 of the three-way valve of FIG. 9 has reduced drawback and leakage relative to other valves, including the Takasago three-way valve illustrated in FIGS. 2-8, when used in conjunction with an application system like that illustrated in FIG. 1. Drawback can occur when the syringe draws solution from the nozzle and jar at the same time during the syringe refilling process. Likewise, drawback can occur when solution is being pumped to the nozzle and a portion of the solution returns to the jar. Leakage, on the other hand, typically occurs when air is entrained into the line through the fittings. This can occur when the threaded connections are loose or damaged. Drawback and leakage can result in low or drifting coating weights.

Spray machines like that of FIG. 1 are commonly subject to daily disassembly of the syringe, valve, nozzle and associated plumbing. This contributes to the above problems that are due to cross-threading or improper plumbing. Also, the valve is subject to solvents and agents that are not only chemically harsh, but can function like glue when dried. As valves fail, they are swapped or repaired. Repairs typically involve replacement of the air pressure diaphragm. Unintended repairs may be accomplished by disassembling the valve to replace the air pressure diaphragm. This disassembly process can loosen bound parts within the valve.

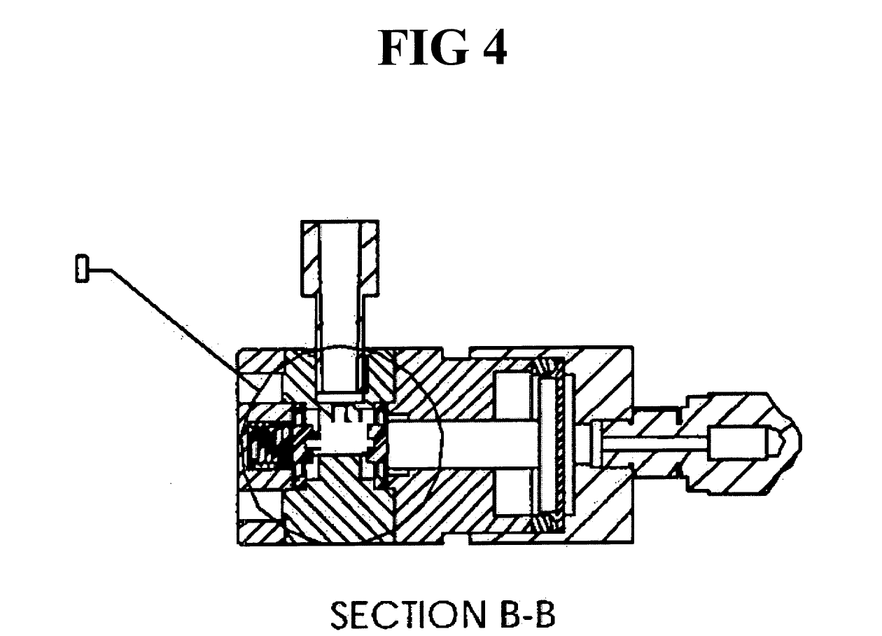

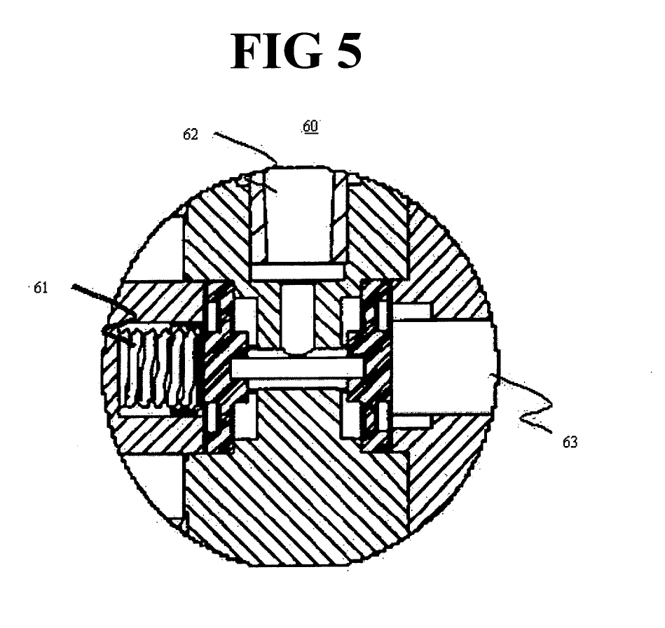

The exemplary embodiment 70 of the three-way valve of FIG. 9 involves a modification of an existing Takasago three-way valve, shown in varying views in FIGS. 2-8. FIG. 2 shows the Takasago three-way valve 20, which includes three ports 22, 25, 26, a valve body 23, a tubing end 21 and another end 24. FIG. 5 shows detail D from FIG. 4. Detail D 60 shows a plunger 63 with a spring return 61 and port 62.

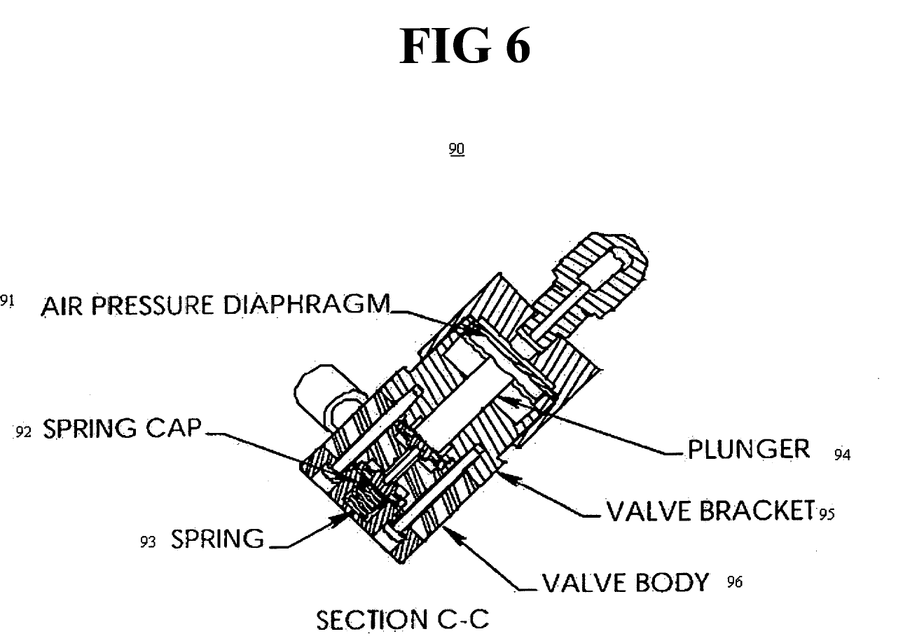

FIG. 6 shows a different cross-sectional view of the Takasago three-way valve 90. Shown are air pressure diaphragm 91, plunger 94, valve bracket 95, valve body 96, spring 93 and spring cap 92. The modification of the existing Takasago three-way valve results in a dual acting pneumatic three-way valve, as compared to the single acting Takasago three-way valve. This modification to a dual acting pneumatic valve creates a default neutral state according to one aspect of the present invention.

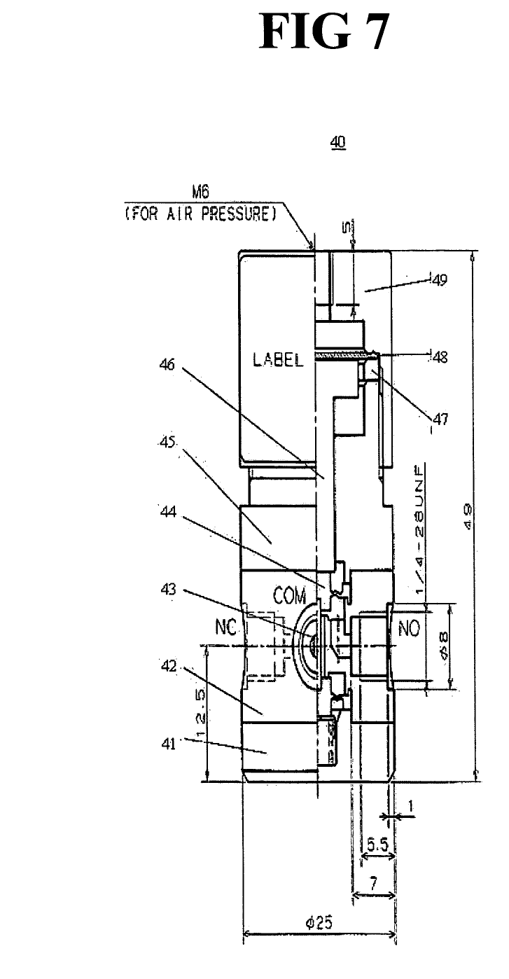

FIG. 7 shows the pneumatic clean valve 40 (model PMDS-2E1/4U-3) used in the Takasago three-way valve. Shown are the mount piece 41, the valve body 42, the valve stem 43, the diaphragm 44, the bracket 45, the rod 46, the spacer 47, the air diaphragm 48 and the head 49. Valve 40 includes a 2-millimeter orifice diameter.

The embodiment 70 in FIG. 9 includes several changes to the Takasago three-way valve to enable the valve to operate with significantly increased reliability.

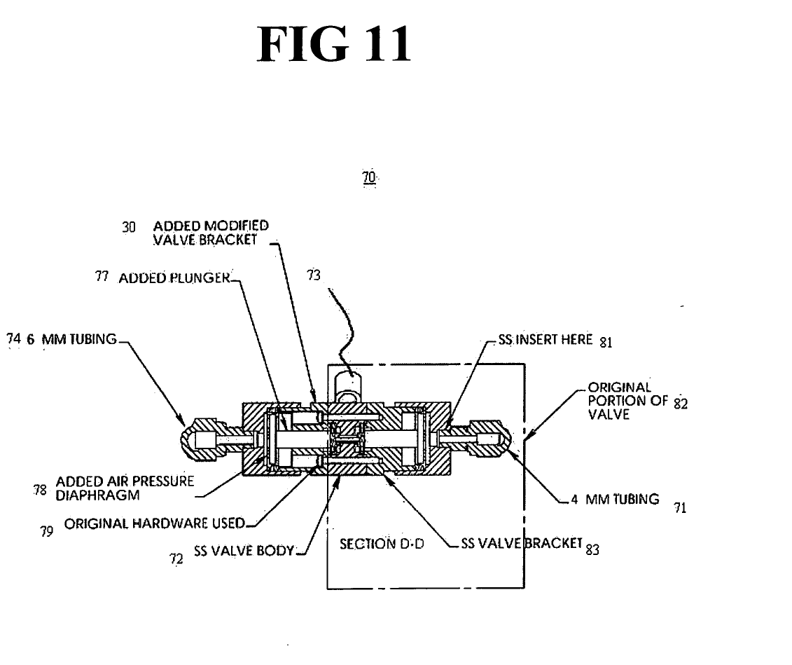

A first modification includes replacing the spring return mechanism (see FIG. 6, element 93 and FIG. 5, element 61) with a second pneumatic return, which is shown in FIG. 11. The portion 82 of the valve 70 in FIG. 11 inside the box is the original portion of the valve. The elements outside the box are the added elements to make the valve 70 operate with a second pneumatic return rather than a spring return mechanism. Thus, a plunger 77 is added along with an air pressure diaphragm 78, a modified valve bracket 30, and a 6-millimeter tubing interconnection 74. Element 79 represents the original hardware used from the original valve that extends outside the box, which can also be seen in FIG. 6.

The above modifications eliminate any problems associated with the spring return mechanism. When the spray coat machine is not in use, neither valve seat is held closed, which eliminates the possibility the valve being glued shut.

Another modification includes eliminating the tapped holes in plastic. This prevents damage to the three-way valve when coupling various connections to the valve.

Yet another modification includes keying of nitrogen tubing connections. This prevents incorrectly connecting the nitrogen source to the valve.

According to another aspect of the present invention, to prevent leaks originating in the air pressure diaphragms, the supply pressure to the valves should be within 300-500 kPa (i.e., 43.5-72.5 psi).

According to another aspect of the present invention, stripped ¼-28 PTFE holes and cross-threaded fittings are avoided by using a valve with a stainless steel body. As a result, disposable fittings become the softer element that will incur any damage. The Upchurch Scientific PEEK compression fittings are difficult to cross-thread in stainless steel, and the small diameter knurled knobs help prevent over-tightening.

To eliminate tapped air (e.g., nitrogen) connections getting stripped, the double acting pneumatic valve employs a stainless steel M6 threaded insert.

To avoid nitrogen lines being swapped, the hoses are labeled or routed in such a manner that does not permit crossing them. The nitrogen tubing that operates the valve will be 4 mm and 6 mm. This keying prevents incorrect nitrogen plumbing if the valve is removed. Using concise diagrams posted on the machine reduces improper plumbing of the solution lines.

The Takasago 3 way valve has a central valve body that is symmetric. This allows the valve to be disassembled and put back together backwards. This also allows a second pneumatic plunger portion of the valve to be attached in place of the spring return, as described above.

These valves of the exemplary embodiment have no plastic threads. The body, mount piece and bracket are stainless steel.

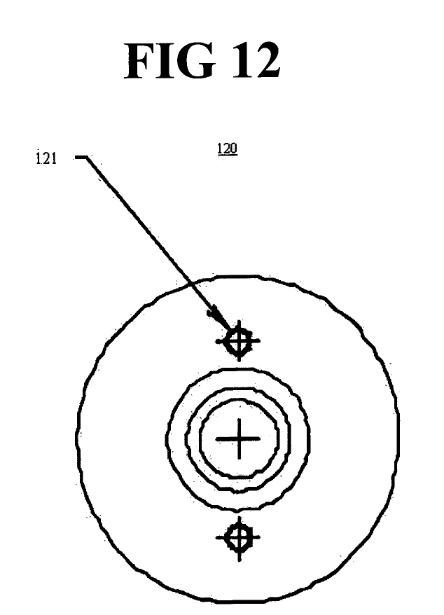

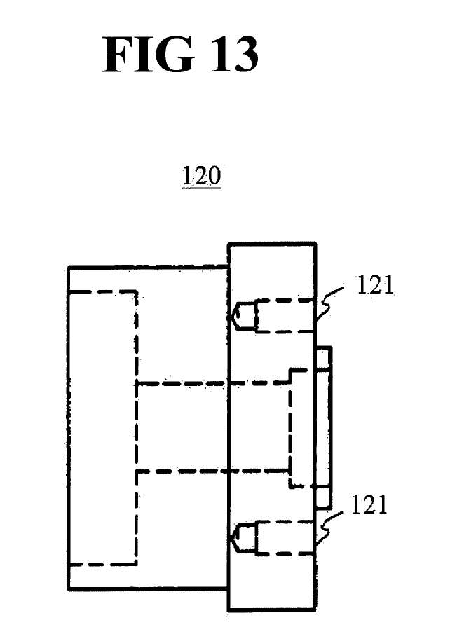

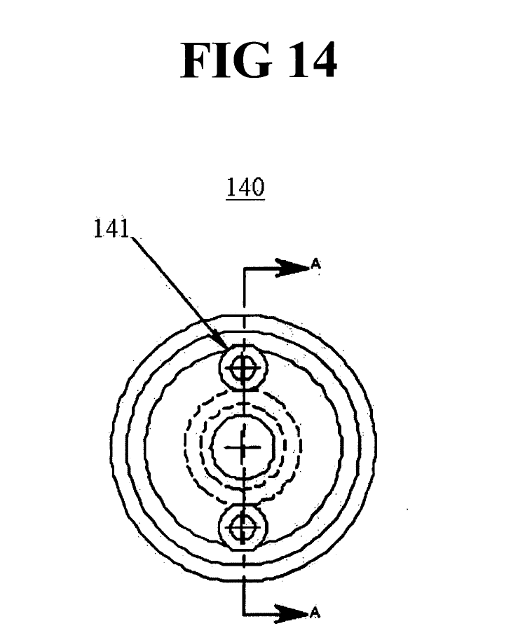

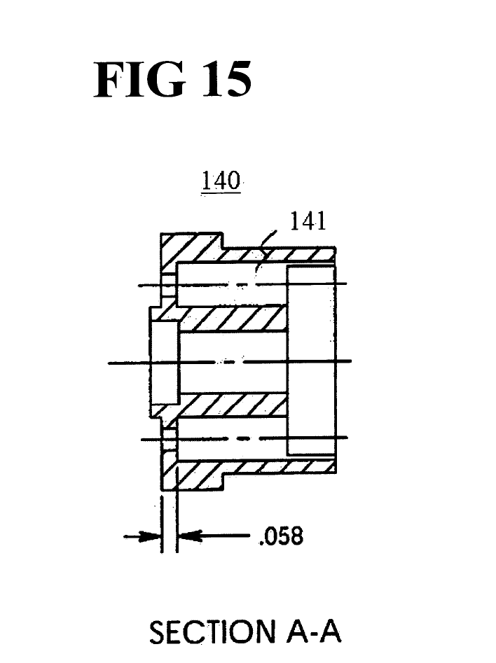

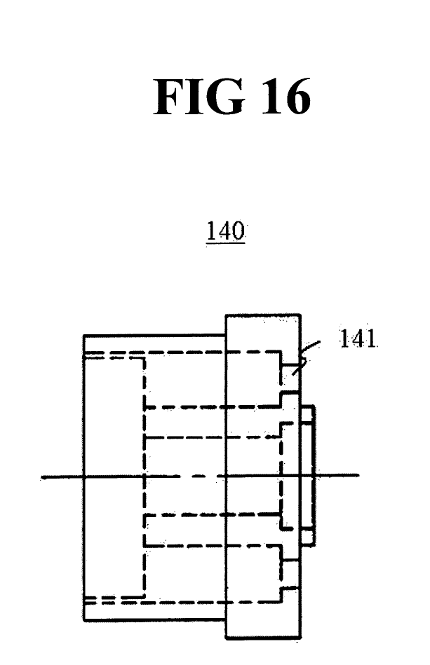

A second valve is utilized to serve as a donor for the second pneumatic plunger portion. The second valve bracket, which has two M2 tapped holes (see element 121 of FIGS. 12-13), are drilled out and counter bored from the opposite side. See elements 141 of FIG. 14-16.

The valve is reassembled using the hardware as shown in FIG. 11. Four (4) mm tubing is used to feed the original pneumatic port and six (6) mm tubing to feed the added pneumatic port. This keying prevents plumbing errors if the valve is removed.

Although various embodiments are specifically illustrated and described herein, it will be appreciated that modifications and variations of the invention are covered by the above teachings and are within the purview of the appended claims without departing from the spirit and intended scope of the invention. Furthermore, these examples should not be interpreted to limit the modifications and variations of the invention covered by the claims but are merely illustrative of possible variations.

1. A medical device coating application unit comprising: a dual pneumatic actuated three-way valve; a solution reservoir containing a coating solution; a solution receptacle; and a solution outlet, said application unit being adapted to (a) withdraw said coating solution from said solution reservoir through said valve and into said solution receptacle when said valve is in a first position and (b) expel said coating solution from said solution receptacle through said valve and through said solution outlet when said valve is in a second position.

2. The medical device coating application unit of claim 1, wherein said three-way valve comprises a default neutral state in which all valve seats of said three-way valve remain open when supply pressure operating said valve is removed.

3. The medical device coating application unit of claim 1, wherein said solution receptacle comprises a syringe.

4. The medical device coating application unit of claim 2, wherein said solution outlet comprises a spray nozzle.

5. A medical device coating application unit comprising:
a dual pneumatic actuated three-way valve comprising first, second and third valve ports and first and second pneumatic ports;
a solution reservoir containing a coating solution in fluid communication with said first valve port;
a solution receptacle in fluid communication with said second valve port; and
a solution outlet in fluid communication with said third valve port, said application unit being adapted to (a) withdraw said coating solution from said solution reservoir through said valve and into said solution receptacle when said valve is pneumatically operated to a first position and (b) expel said coating solution from said solution receptacle through said valve and through said solution outlet when said valve is pneumatically operated to a second position.

6. The medical device coating application unit of claim 5, wherein each of said pneumatic ports has coupled thereto a supply pressure source that provides a supply pressure within a range of about 300 kilo-Pascals to about 500 kilo-Pascals.

7. The medical device coating application unit of claim 5, further comprising a first tube having a first diameter coupled to said first pneumatic port and a second tube having a second diameter coupled to said second pneumatic port.

8. The medical device coating application unit of claim 5, wherein said first and second pneumatic ports are provided with stainless steel threaded inserts.

9. The medical device coating application unit of claim 5, wherein said three-way valve comprises a stainless steel body.

10. The medical device coating application unit of claim 5, further comprising one or more disposable fittings.

11. The medical device coating application unit of claim 5, wherein said three-way valve comprises a default neutral state in which all valve seats of said three-way valve remain open when supply pressure operating said valve is removed.

12. The medical device coating application unit of claim 5, wherein said solution receptacle comprises a syringe.

13. The medical device coating application unit of claim 5, wherein said solution outlet comprises a spray nozzle.

14. A method of loading a medical device coating application unit, said method comprising:
providing the medical device coating application unit of claim 1, wherein said three-way valve is in said first position; and
withdrawing said coating solution from said solution reservoir and into said solution receptacle.

15. A method for coating a medical device comprising:
providing a medical device;
providing the medical device coating application unit of claim 1, wherein said solution receptacle contains said coating solution and wherein said three-way valve is in said second position; and
coating said medical device by expelling said coating solution from said solution receptacle, through said solution outlet, and onto said medical device.

16. The method of claim 15, further comprising:
establishing said three-way valve in said first position; and
withdrawing said coating solution from said solution reservoir and into said solution receptacle, thereby refilling said solution receptable.

17. The method of claim 16, further comprising:
providing am additional medical device;
establishing said three-way valve in said second position; and
coating said additional medical device by expelling said coating solution from said solution receptacle, through said solution outlet, and onto said additional medical device.

18. A method for coating a medical device comprising:
providing the medical device coating application unit of claim 1;
establishing said three-way valve in said first position;
withdrawing said coating solution from said solution reservoir and into said solution receptacle;
establishing said three-way valve is in said second position; and
coating a medical device by expelling said coating solution from said solution receptacle, through said solution outlet, and onto said medical device.

19. The method of claim 18, further comprising maintaining all valve seats of the three-way valve open when the medical device coating application unit is not in use.

20. The method of claim 18, comprising controlling the three-way valve with a supply pressure source having a supply pressure within a range of about 300 kilo-Pascals to about 500 kilo-Pascals.
